(19) United States
(12) Patent Application Publication
(10) Pub. No.: US 2025/0162844 A1
(43) Pub. Date: May 22, 2025

(54) GANTRY CRANE AND ASSOCIATED METHOD OF ERECTION

(71) Applicants: SAFRAN LANDING SYSTEMS, Velizy-Villacoublay (FR); SAFRAN LANDING SYSTEMS UK LTD., Gloucester (GB)

(72) Inventors: Julien PACAUD, MOISSY-CRAMAYEL (FR); Armel VACHON, MOISSY-CRAMAYEL (FR); Grégoire DE LAITRE, MOISSY-CRAMAYEL (FR); Edoardo MUSGHI, MOISSY-CRAMAYEL (FR); Tom BOARDMAN, MOISSY-CRAMAYEL (FR)

(73) Assignees: SAFRAN LANDING SYSTEMS, Velizy-Villacoublay (FR); SAFRAN LANDING SYSTEMS UK LTD., Gloucester, GL (GB)

(21) Appl. No.: 18/839,365

(22) PCT Filed: Feb. 17, 2023
(86) PCT No.: PCT/FR2023/050230

§ 371 Date: Aug. 16, 2024

(30) Foreign Application Priority Data
Feb. 18, 2022 (FR) 2201477

(51) Int. Cl. B66C 17/00; B66C 23/78

(52) U.S. Cl. CPC B66C 17/00; B66C 23/78

(57) ABSTRACT

A gantry crane and associated method of erection, the gantry including a frame having at least three first members; a longitudinal rail supported by the frame; and at least three second members extending between a first end portion and an opposite second end portion. Each second member can be connected to the frame by means for rigid connection and continuous rotational movement of the second member relative to the frame between a first position in which the second member forms an angle of less than 90° with the first plane and a second position in which the second member is substantially perpendicular to the first plane.

### TECHNICAL FIELD

This disclosure relates to a gantry crane and a method of erecting this gantry crane.

### PRIOR ART

For lifting a heavy mechanical part, it is known to use a gantry crane provided with a lifting device such as a hoist, suitable for connecting directly or indirectly to the mechanical part to be lifted.

The gantry crane comprises two legs extending from the ground in a first direction, in particular in a vertical direction. The legs are connected together by a beam from which the lifting device is suspended. In some cases, the lifting device is connected to the beam in a fixed manner, with no movement of the lifting device along the beam being permitted. In other cases, the beam forms a rail along which the lifting device can move.

The gantry beam is arranged at a sufficient distance from the ground to allow the mechanical part to be lifted to a desired height. Due to the weight of the beam, its assembly to the legs of the gantry at such a distance requires the use of heavy machinery which is not available at all locations, or of excessive human force which requires the intervention of several operators and poses a physical risk to them.

Furthermore, the gantry known from the prior art is not sufficiently rigid and stable for lifting and moving heavy mechanical parts, which endangers the operators working near the gantry, in particular those working under it.

### SUMMARY

This disclosure improves the situation.

To this end, a gantry crane is proposed comprising:
a frame comprising at least three first members extending parallel to a first plane and each comprising a first end portion and an opposite second end portion, each of the first and second end portions of one of the first members being connected to another respective first member;
a longitudinal rail supported by the frame and extending parallel to said first plane and on which a lifting device for lifting a mechanical part is hinged for longitudinal movement; and
at least three second members extending between a first end portion and an opposite second end portion, the first end portion of each second member being hinged to rotate on the frame about an axis parallel to the first plane, each second member further being connected to the frame by means for rigid connection of the second member to the frame and for continuous rotational movement of the second member relative to the frame between a first position in which the second member forms an angle of less than 90° with the first plane and a second position in which the second member is substantially perpendicular to said first plane.

In one practical example, the first members are initially placed on a support at a distance from the ground, then are connected together to obtain the frame. In a subsequent step, a second member is rotatably connected to the frame by its first end, the second end being oriented towards the ground. It is understood that in this position, corresponding to the first position, the second member forms an angle of less than 90° with the first plane. The same operation is repeated for each second member. After having connected all the second members to the frame, the means for rigid connection and movement are actuated so that the second members are moved to their second position, which corresponds to an operational position, meaning the position of the members when the gantry crane is working.

Because of the means for rigid connection and movement of the second members, it is possible to raise the frame to a desired height, in particular to a height allowing operators to work under the gantry, without using lifting means external to the gantry or human force. Also, the gantry can be installed at any location with no need to transport heavy machinery and without endangering the health of the operators installing it.

Furthermore, the presence of at least three first members makes it possible to increase the resistance of the gantry to raised loads raised when in service, in particular to the weight of said mechanical part.

Finally, the presence of at least three second members allows improving the stability of the gantry, particularly when in their second position, which improves the safety of any operator working under the gantry.

Advantageously, the first plane extends substantially parallel to the ground on which the gantry is installed, when the second members are in the first position as well as the second position.

According to one aspect of the invention, the means for rigid connection and continuous movement are specific to each second member and are independent of the means for rigid connection and continuous movement of the other second members.

The means for rigid connection and continuous movement of each second member thus make it possible to move the respective second member between the first position and the second position independently of the means for rigid connection and continuous movement of the other second members.

According to one aspect of the invention, the means for rigid connection and continuous movement comprise a rack and pinion winch connected to each second member.

The rack and pinion winch may be manual or motorized. In the manual case, it is provided with an actuating element, such as a crank, which allows the operator to control the movement of the respective second member between the first and second positions, in a simple manner and without requiring significant physical effort. In the motorized case, the operator can control this movement without exerting any physical effort. In some cases, the motorized rack and pinion winch may be controlled remotely.

The rack and pinion winch has sufficient lifting capacities to allow moving the respective second member between the first and second positions despite the high weight of the frame, which is around 150 kg.

According to one aspect of the invention, the gantry further comprises a plurality of stiffeners, each stiffener connecting one of the first members to one of the second members.

According to the invention, each second member is connected to two first members. The number of stiffeners is thus two times the number of second members.

According to the invention, each stiffener comprises a connecting bar which is rigid and of constant length. It connects the first end portion of a second member to a first member.

The plurality of stiffeners makes it possible to improve the stability of the gantry and to increase its resistance to raised loads. The stiffeners also make it possible, once fixed at the two ends, to create a fixed connection between a first member and a second member. In this assembled position, rotation of the second member about its axis is no longer permitted.

According to one aspect of the invention, the second end portion of each second member comprises a raising member configured to move the respective second member substantially perpendicularly to the first plane when the second members are in the second position.

By means of the raising elements, the height at which the frame is located relative to the ground may be incremented. This makes it possible to adjust this height so that, if the gantry is used to install the raised mechanical part in a dedicated space, the height of the frame relative to the ground ensures that this part is aligned with said space before installation. This is the case, for example, when arranging an axle in a bore of a bogie.

According to one aspect of the invention, the second end portion of each second member comprises a rolling element.

The rolling element facilitates movement on the ground of each second member, a single operator thus being able to move each second member about on the ground in order to connect its first end portion to the frame.

According to one aspect of the invention, the first members, the second members, the rail, and the means for rigid connection and continuous movement each form a unit part, these parts being connected by removable connections.

Since the connections are removable, the gantry may be dismantled and stored in a compact manner, allowing it to be easily transported by land, sea or air.

According to one aspect of the invention, the gantry comprises four first members and four second members arranged so as to form a generally cubic structure.

The presence of four second members makes it possible to further increase the stability of the gantry when the second members are in the second position.

According to one aspect of the invention, each first member and the rail have a weight of less than or equal to 50 kg. Preferably, each first member and the rail have a weight of less than or equal to 40 kg. For example, each member and the rail may have a weight of less than or equal to 36 kg.

Each first member and the rail may thus be transported by only two operators while complying with legislation which sets the maximum load an operator may carry at 25 kg.

According to another aspect, a method of erecting a gantry crane is proposed, comprising:
a) assembling the frame by connecting each of the first and second end portions of one of the first members to another respective first member;
b) assembling the rail on the frame;
c) connecting the first end portion of each second member to the frame, the first end portion of each second member being hinged to rotate on the frame about an axis parallel to the first plane;
d) connecting each second member to a first member via said means for rigid connection and continuous movement;
e) rotating each second member about the axis parallel to the first plane, between the first position obtained in step d) and the second position, by actuating the means for rigid connection and continuous movement.

As indicated above, in order to assemble the frame, the first members are placed on the support at a distance from the ground, then connected together. According to the invention, the support may comprise a plurality of independent support elements such as trestles, preferably as many support elements as there are first members. The first end portion of each first member may thus rest on one of the support elements, and the second end portion of each first member on another of the support elements.

Advantageously, the height of the support elements is less than or equal to 1 m, preferably between 0.8 m and 1 m. The operators therefore do not have to exert significant physical effort in order to place the first members on the support element units.

Because of the means for rigid connection and movement of the second members, the method of erecting the gantry according to the invention does not require the use of heavy machinery, and the use of human force is limited to what is used to arrange the first members on the support element units and to assemble the rail on the frame.

According to one aspect of the invention, the method of erecting the gantry further comprises connecting the respective stiffener between each first member and each second member after moving each second member between the first position and the second position.

Because the stiffeners are connected after each second member is moved into the second position, it is possible to use rigid stiffeners.

According to one aspect of the invention, the method further comprises installing each raising element after each second member is moved between the first position and the second position.

According to the invention, in a retracted position of each raising element, the second end portion of each second member is in contact with the ground on which the gantry is put into service, but in a deployed position of each raising element, the second end portion of each second member is separated from the ground by a distance equal to a deployment length of each raising element.

In a variant, the raising members may be pre-mounted on each second member and be movable thereon from a standby position to an operational position.

This document also relates to a method for mounting an axle in a bore of a bogie mounted on a landing gear of an aircraft, the landing gear being in a gear-down position, the bogie bore extending in a substantially horizontal direction referred to as the axle installation direction, between a first open end and a second open end, the method comprising:
a) supplying a mobile supporting structure comprising means for moving the axle which are movable along a direction substantially parallel to the axle installation direction,
b) installing the axle on the means for moving the axle,
c) aligning the axis of the axle with the axis of the bore,
d) inserting the axle into said bogie bore by moving the means for moving the axle in the direction substantially parallel to the axle installation direction.

Because the axle is inserted into the bogie bore in the axle installation direction, which is substantially horizontal, the method for mounting an axle allows installing the axle in the bogie bore without needing to disassemble the bogie from the landing gear. The axle may even be installed under the wing of the plane. This makes it possible to simplify the mounting of the axle in the bore as well as to accelerate the mounting of the axle in the bore, reducing the costs related a grounded aircraft.

The method may comprise a step prior to step d), comprising introducing the axle in a horizontal position into a tank filled with liquid nitrogen, for a given time, for example one hour.

Introducing the axle into the tank filled with liquid nitrogen allows cooling the axle to a temperature of approximately −200° C., causing contraction of the axle which facilitates its insertion in the bore. Once in the bore, the temperature of the axle rises to ambient temperature, which causes the axle to expand, leading to an increase in its outer diameter until it is automatically locked in place by its expansion in the bore at ambient temperature.

According to one aspect, step c) comprises:
positioning a reference mark on the mobile supporting structure in such a manner that the axis of the bore intercepts said reference mark, and
positioning the axle so that its axis is aligned with said reference mark along the installation direction.

Because the reference mark is positioned so that it is intercepted by the axis of the bogie bore, alignment between the axis of the axle and the reference mark also implies that the axis of the axle is aligned with the axis of the bore. The axle may therefore easily be inserted into the bore with no risk of collision between axle and bore during this insertion.

The reference mark may be arranged in a vertical plane comprising the installation direction, this plane corresponding to a lifting plane of the axis of the axle.

With the reference mark arranged in the lifting plane of the axis of the axle, it is sufficient simply to adjust the position of the axis of the axle in a substantially vertical direction in order to align the reference mark and said axis of the axle, which allows aligning the axis of the axle with the axis of the bogie bore.

The method may comprise mounting a laser beam device in the bogie bore so that the axis of the laser beam is coaxial with the axis of the bogie bore.

According to one aspect, the laser beam will be visible on the reference mark. The axis of the laser beam being coaxial with the axis of the bogie bore, an alignment between the mark and the laser beam allows ensuring the alignment between the axis of the bore and the reference mark.

According to one aspect, step d) is preceded by a step comprising the mounting of a sleeve around a first end of the axle, said first end being arranged facing the bogie bore along the axle installation direction.

The sleeve may be made of a flexible material, such as plastic. This sleeve helps cushion any collisions that may occur between the axle and the bogie bore during step d).

This document also relates to a system for implementing a method for mounting an axle in a bore of a bogie mounted on a landing gear of an aircraft, the landing gear being in a gear-down position, the bore extending in a substantially horizontal direction referred to as the axle installation direction, between a first open end and a second open end, the system comprising:
a mobile supporting structure,
means for aligning the axis of the bogie bore with the axis of the axle,
means for moving the axle into a position for insertion into the bogie bore and for mounting the axle in the bogie bore.

The system allows the axle to be mounted in the bore in a substantially horizontal direction. There is therefore no need to disassemble the bogie from the landing gear in order to mount the axle in the bore. The system could in particular be placed under the wing of the aircraft in order to mount the axle directly in this position. The system therefore allows simplifying the mounting of the axle and reducing its cost.

The system may further comprise a tank filled with liquid nitrogen.

The tank filled with liquid nitrogen allows the axle to be cooled before its insertion into the bore. This causes contraction of the axle which facilitates its insertion into the bore. Once in the bore, the temperature of the axle rises to ambient temperature, causing the axle to expand which allows fitting the axle tightly into the bogie bore without any further fastening element.

The alignment means may comprise a reference mark carried by the mobile supporting structure and a laser beam device shaped for installation in the bogie bore so that the axis of the laser beam is coaxial with the axis of the bogie bore.

A position of the reference mark may be adjusted so that the laser beam intercepts the reference mark. Because the axis of the laser beam is coaxial with the axis of the bogie bore, the system allows easily aligning the reference mark and the axis of said bore.

The system may further comprise means for moving the reference mark, comprising at least one rolling element configured for moving the supporting structure along a horizontal plane, and at least one raising member for the supporting structure configured for moving the supporting structure in translation along a substantially vertical direction.

By means of the rolling element and the raising member, the reference mark may be moved along the horizontal plane and along the substantially vertical direction until the laser beam intercepts the reference mark, which allows ensuring the alignment between the mark and the axis of the bore.

According to one aspect, the supporting structure comprises an upper frame supported by a plurality of vertical members, the upper frame supporting the means for moving the axle into a position for insertion into the bogie bore and for mounting the axle in the bogie bore.

The means for moving the axle are in particular arranged so that, once the reference mark is aligned with the axis of the bore, the means for moving the axle are moved in a direction substantially parallel to the axis of the bore. This makes it easy to align the axle with the bore.

According to one aspect, the means for moving the axle comprise a rail supported by the upper frame and a hoist mounted to move in translation on the rail along the axle installation direction.

The hoist allows the axle to be lifted to a position of alignment between the axis of the axle and the axis of the bore. Because the hoist is mounted to move in translation on the rail along the axle installation direction, the axle is inserted directly into the bore by this movement of the hoist once the axle is aligned with the axis of the bogie bore.

The reference mark may be fixedly mounted relative to the rail and arranged in a plane comprising the axle installation direction and the direction of translational movement of the hoist on the rail.

Because the reference mark is fixedly mounted relative to the rail, the movements of the supporting structure due to the rolling element and the raising member do not change the relative position between the reference mark and the rail.

The hoist may be configured so that, in the high position, the axle is by necessity positioned with its axis aligned with the reference mark.

Alignment between the axle and the reference mark is thus obtained by positioning the hoist in the high position. Alignment between the axle and the mark is therefore easily obtained and reduces the risk of error.

### BRIEF DESCRIPTION OF DRAWINGS

Other features, details and advantages will become apparent upon reading the detailed description below, and upon analyzing the attached drawings, in which:

FIG. 1 is a schematic perspective view of a gantry crane according to the invention, in a low operational position.

FIG. 2 is a schematic perspective view of the gantry crane of FIG. 1, in a high operational position.

FIG. 3 is a schematic perspective view of a means for rigid connection and continuous movement, installed on the gantry crane of FIG. 1.

FIG. 4 is a schematic perspective view of a frame of the gantry crane of FIG. 1 arranged on a support.

FIG. 5 is a schematic side view of the gantry crane of FIG. 1 in another position.

FIG. 6 is a schematic perspective view of a system for mounting an axle on a bogie installed on the landing gear of an aircraft, the system comprising the gantry of FIG. 1.

FIG. 7 is a schematic view of the system and landing gear of FIG. 6, viewed from a different orientation.

FIG. 8 is a schematic perspective view of the gantry of FIG. 1 when it is part of the system of FIGS. 6 and 7.

FIG. 9 is a schematic perspective view of an axle support of the system of FIGS. 6 and 7.

FIG. 10 is a schematic perspective view of a tank of the system of FIGS. 6 and 7.

FIG. 11 is a schematic perspective view of the axle support of FIG. 9 supporting the axle and introduced into the tank of FIG. 10.

FIG. 12 is a schematic perspective view of the axle support of FIG. 9 supporting the axle, and of the tank of FIG. 10.

FIG. 13 is a schematic perspective view of a laser of the system of FIGS. 6 and 7 and of details of the bogie.

FIG. 14 is a schematic perspective view of details of the bogie when the axle supported by the axle support is inserted into the bogie bore.

### DESCRIPTION OF EMBODIMENTS

In this description, the various elements will be defined in the three perpendicular directions of space. In particular, an orthonormal frame of reference will be used comprising a first direction X, a second direction Y, and a third direction Z which are orthogonal to each other. First direction X and second direction Y are substantially horizontal, so as to form a substantially horizontal plane XY between them. Third direction Z is substantially vertical and forms a plane XZ with first direction X, as well as a plane YZ with second direction Y. Planes XZ and YZ are substantially vertical.

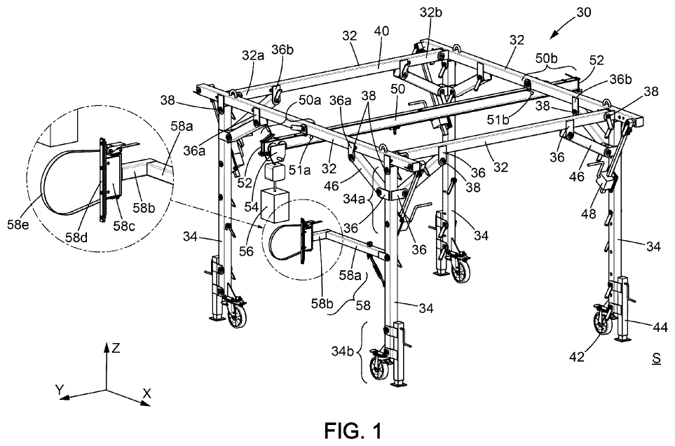

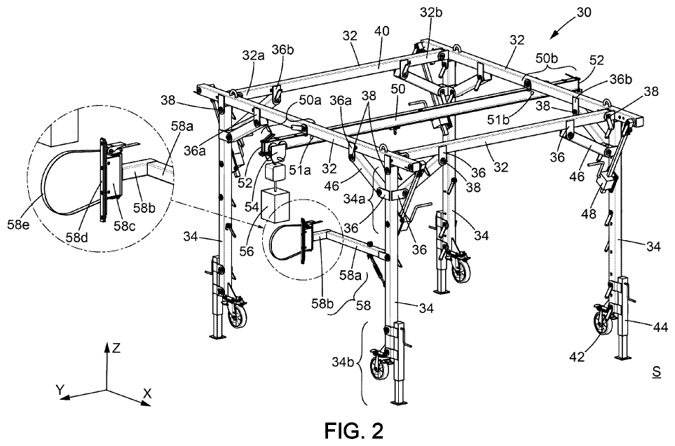

A gantry crane 30, or supporting structure, will now be described with reference to FIGS. 1 and 2. In these figures, the gantry is placed on the ground S which extends along plane XY, without this being limiting.

The gantry comprises a plurality of first members 32 and a plurality of second members 34.

The first members extend parallel to a first plane. In FIGS. 1 and 2, the plurality of first members 32 extend substantially parallel to plane XY, substantially horizontal, while the plurality of second members 34 extend in direction Z, substantially vertical. For this reason, and for semantic simplification, in the following the first members will be referred to as “horizontal members” and the second members will be referred to as “vertical members”.

Advantageously, the gantry comprises at least three horizontal members 32 and at least three vertical members 34. In the present case, the gantry comprises four horizontal members and four vertical members arranged so as to form a generally cubic structure. In particular, to form such a cubic structure, the horizontal members are in parallel pairs, two horizontal members extending in direction X and two horizontal members extending in direction Y.

Each horizontal member 32 comprises a first end portion 32a and an opposite second end portion 32b. Each end portion 32a, 32b is adapted to connect two horizontal members 32 together. In particular, each end portion 32a, 32b of horizontal members 32 is connected to another respective horizontal member. In the example of FIGS. 1 and 2, each of end portions 32a, 32b of the horizontal members extending substantially parallel to direction X is connected to one of the end portions of a respective horizontal member extending substantially parallel to direction Y.

Two horizontal members 32 are advantageously connected to each other by a removable connection. To this end, each end portion of the horizontal members may for example be provided with at least one connector 36 or at least one bore (not visible).

Each bore extends in a plane substantially parallel to plane XY and passes through horizontal member 32 comprising it in a direction substantially perpendicular to the direction of extension of this member. Thus, for example, for horizontal members 32 extending substantially in direction X, a bore made in one of their end portions extends substantially in direction Y.

Each connector 36 extends from the respective end portion in the direction of extension of the horizontal member 32 with which this end portion is connected. According to one non-limiting exemplary embodiment of the invention, each connector 36 comprises two assembly tabs 36a, 36b arranged opposite each other. Each assembly tab 36a, 36b comprises a hole (not visible in the figures). The holes of the two assembly tabs 36a, 36b are aligned with each other.

In order to connect two horizontal members 32, horizontal member 32 comprising the bore is arranged between assembly tabs 36a, 36b of the connector of the other horizontal member 32 so that the holes of the assembly tabs and the bore are aligned. A removable connecting element 38, such as a rod, may then be arranged so that it traverses the two holes of connector 36 and the bore. Two horizontal members 32 are thus connected to each other and held in position relative to each other.

When all horizontal members 32 are connected, they form an upper frame 40 of gantry 30. Frame 40 carries a rail 50 extending in a longitudinal direction 50 substantially parallel to plane XY. In FIGS. 1 and 2 the longitudinal direction corresponds to direction Y, this being not limiting. Rail 50 will be described in more detail below.

Each end portion 32a, 32b is further adapted to connect horizontal members 32 to vertical members 34 as explained below. To this end, each end portion of horizontal members 32 may comprise at least one connector 36 as described above, but extending substantially parallel to direction Z.

Vertical members 34 support upper frame 40 of the gantry, as is clearly shown in FIGS. 1 and 2. In the non-limiting example of the figures, each vertical member 34 is arranged opposite another vertical member 34 along first direction X, and opposite another vertical member 34 along second direction Y.

Each vertical member 34 comprises a first end portion 34a and a second end portion 34b which are opposite each other.

First end portion 34a is adapted to be connected to at least two horizontal members. More precisely, first end portion 34a is adapted to be connected to one of end portions 32a, 32b of at least two horizontal members.

Preferably, the connection between first end portion 34a of each vertical member 34 and the respective horizontal members 32 is removable. For this purpose, each first end portion 34a of vertical members 34 comprises one or more connectors 36 similar to those described above, and/or one or more bores (not visible). In the non-limiting example of the figures, first end portion 34a of each vertical member 34 comprises a bore (not visible), a connector 36 extending substantially in first direction X, and a connector 36 extending substantially in second direction Y.

In this configuration, in order to connect one of vertical members 34 to one of horizontal members 32, vertical member 34 is placed between the assembly tabs of connector 36 of the respective horizontal member which extends substantially parallel to direction Z. Vertical member 34 is in particular placed between the assembly tabs of connector 36 so as to align the holes of the assembly tabs with the bore through the vertical member. A removable connecting element 38, for example similar to the one used to connect two horizontal members 32, may then be arranged so that it traverses the two holes of the connector and the bore of the vertical member. Vertical member 34 and horizontal member 32 are thus directly connected to each other by removable connecting element 38 and are held in position relative to each other.

Advantageously, each vertical member 34 connected directly to the respective horizontal member 32 by removable connecting element 38 is hinged to rotate on frame 40 about an axis parallel to the plane parallel to horizontal members 32, in this case plane XY. The axis of rotation of each vertical member 34 is for example aligned with removable connecting element 38 which allows directly connecting each vertical member 34 to the respective horizontal member 32. As will be detailed below, each vertical member 34 may thus be moved between a first position in which the respective vertical member forms an angle of less than 90° with frame 40, and a second position, visible in FIGS. 1 and 2, which corresponds to an operational position of each vertical member 34. “Operational position” of each vertical member 34 is understood to mean the position of each vertical member when gantry 30 is operational, meaning when it is possible to use it to raise a mechanical part. In FIGS. 1 and 2, in the operational position, vertical members 34 extend substantially perpendicular to plane XY, meaning in direction Z.

Second end portion 34b is placed on a lower area of the respective vertical member 34, relative to direction Z. Second end portion 34b thus forms a foot of each vertical member 34. As can be seen in FIGS. 1 and 2, each foot 34b may be provided with a rolling element 42 and a raising member 44 for the gantry.

Rolling element 42 is for example a wheel enabling the gantry to be moved along plane XY. Preferably, wheel 42 is able to rotate about an axis substantially parallel to the respective vertical member through an angle of 360°. The gantry can thus easily be moved in all directions comprised within plane XY, even by a single operator.

Advantageously, wheel 42 comprises a holding brake which blocks movement of the wheel, and therefore movement of the gantry, within plane XY when it is actuated.

Raising member 44 is for example a cylinder. Preferably, raising member 44 is removably connected to foot 34b.

Raising member 44 is configured to move between a retracted position, visible in FIG. 1, and a deployed position, visible in FIG. 2. This makes it possible to move gantry 30 substantially perpendicularly to the plane parallel to the horizontal members. In the present case, the raising member makes it possible to move the gantry along direction Z. Gantry 30 may thus be moved between a low first position or position of minimum height, visible in FIG. 1, to a high second position or position of maximum height, shown in FIG. 2.

Raising member 44 is configured to be able to raise gantry 30 continuously from a low first position or position of minimum height, visible in FIG. 1, to a high second position or position of maximum height, shown in FIG. 2.

The raising member may be operated manually. In one configuration, raising member 44 of each foot 34a is actuated independently of raising members 44 of the other feet 34a. In another configuration, gantry 30 may comprise synchronous raising members for all vertical members 34, to allow simultaneously lifting all feet 34b together by a single command.

Gantry 30 is therefore movable in the three perpendicular directions of space X, Y, Z, due to rolling element 42 and raising member 44.

Gantry 30 may further comprise a plurality of stiffeners 46. In the present case, each stiffener 46 comprises a connecting bar, without this being limiting. Connecting bar 46 is for example a rigid bar of constant length.

Each connecting bar 46 connects one of horizontal members 32 to one of vertical members 34. In particular, each connecting bar 46 may be arranged between each free connector 36 arranged on the second end portion of vertical member 34 and one of free connectors 36 arranged on the end portions of horizontal members 32. “Free connector” is understood to mean a connector which has not yet been used to connect two members 32, 34 together. In the present case, each vertical member 34 is connected to two horizontal members 32. The number of connecting bars 46 is thus twice the number of vertical members 34.

As can be seen in FIGS. 1 and 2, each connecting bar 46 extends substantially diagonally between one of vertical members 34 and one of horizontal members 32. Connecting bar 46 comprises two ends, each advantageously comprising a hole (not visible in the figures) which allows linking connecting bar 46 to connectors 36 of the vertical 34 and horizontal 32 members which it connects. In particular, a removable connecting element 38, for example similar to the one used to connect two horizontal members, may be used to connect each connecting bar 46 between the respective vertical 34 and horizontal 32 members.

The plurality of stiffeners 46 allows improving the stability of the gantry and increasing its resistance to raised loads. Each stiffener 46 also allows creating a fixed connection from one of horizontal members 32 to one of vertical members 34.

Gantry 30 further comprises means for rigid connection of each vertical member 34 to frame 40 and for continuous rotational movement of each vertical member 34 relative to frame 40. Advantageously, each vertical member 42 has means for rigid connection and continuous movement which are specific to it and independent of the means for rigid connection and continuous movement of the other vertical members.

In the figures, the means for rigid connection and continuous movement comprise a plurality of winches 48.

Each winch 48 is arranged between a vertical member 34 and a horizontal member 36. Preferably, all winches 48 extend in the same plane, in particular plane XZ or plane YZ. In other words, each winch 48 is arranged between each of vertical members 34 and only those of horizontal members 36 which extend substantially parallel to a single direction. For example, in FIGS. 1 and 2, four winches are installed, each winch connecting first end portion 34a of respective vertical member 34 and one of the end portions of those horizontal members 32 which extend substantially parallel to first direction X. All winches 48 therefore extend in plane XZ in the example in FIGS. 1 and 2. Conversely, in these figures, no winch 48 is installed between respective vertical member 32 and those horizontal members 32 which extend substantially in second direction Y. No winch 48 therefore extends in plane YZ in the example in FIGS. 1 and 2.

Winch 48 allows imparting to respective vertical member 34 a rotational movement about an axis parallel to the plane parallel to horizontal members 32, in this case about an axis parallel to the direction of extension of horizontal member 32 to which winch 48 connects it. Thus, as indicated above, each vertical member 34 may be moved between the first position where the respective vertical member forms an angle of less than 90° with frame 40, and the operational position visible in FIGS. 1 and 2.

As indicated above, each winch 48 is independent of the other winches 48. This allows moving each vertical member 34 between the first position and the second position, or operational position, independently of the other vertical members 34.

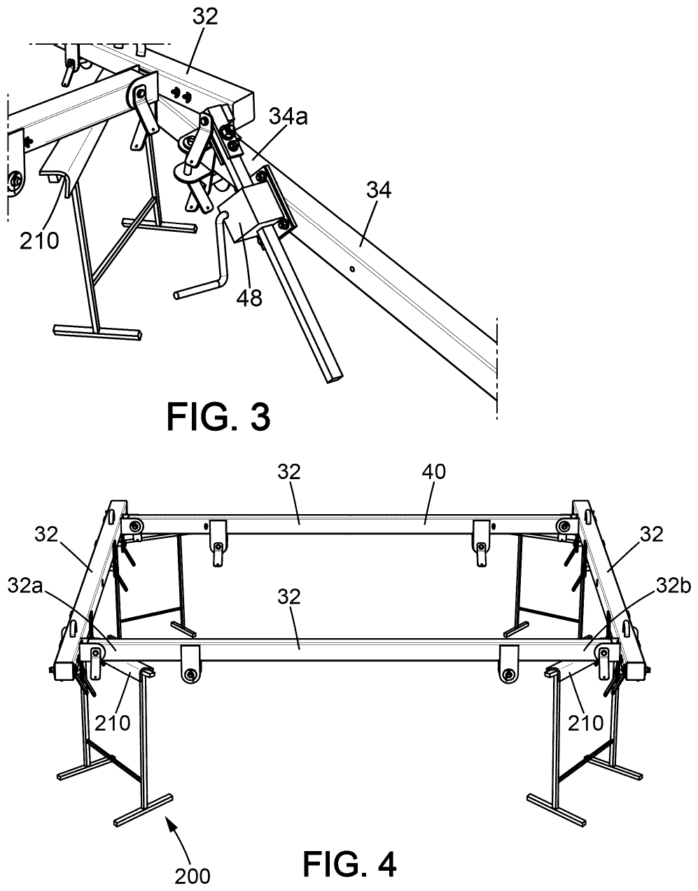

As can be seen from FIG. 3, each winch 48 may be a rack and pinion winch. In certain cases, the rack and pinion winch is a manual winch provided with an actuating element, such as a crank, which allows the operator to control movement of the respective second member between the first and second positions in a simple and effortless manner and without requiring significant physical effort. In other cases, the rack and pinion winch is motorized, the operator being able to control this movement without exerting any physical effort and possibly remotely.

Note that the means for rigid connection and continuous movement may allow arranging the vertical members in a multitude of positions between the first position and the operational position.

As indicated above, gantry 30 further comprises a longitudinal rail 50. The rail is connected to upper frame 40, preferably by a removable type of connection, similar to the one used to connect the horizontal members together.

Advantageously, rail 50 extends substantially transversely to at least one of the horizontal members. Advantageously, rail 50 is connected to two horizontal members 32. For example, in FIGS. 1 and 2, rail 50 is connected to two horizontal members 32 arranged opposite each other along direction Y. Rail 50 comprises a first end portion 50a and a second end portion 50b which are opposite each other. Each of first and second end portions 50a, 50b is provided with a locking element 52 for rail 50, movable between a locking position and an unlocking position for rail 50. First end portion 50a of the rail may further comprise a first hole 51a and a second hole 51b.

Rail 50 advantageously has an H shape. Due to the H shape, a device for lifting a mechanical part may be hinged for longitudinal movement on rail 50. The lifting device comprises for example a hoist trolley 54 connected to a hoist 56. Hoist 56 may thus be connected to rail 50 via trolley 54.

Trolley 54 is mounted to be movable in translation along the longitudinal direction of rail 50, in this case the direction substantially perpendicular to direction X. Hoist 56 is then integral with the movements of trolley 54 along rail 50.

Hoist 56 comprises a chain (not shown) which is movable substantially along direction Z between a low position and a high position. As will be detailed below, this allows moving the mechanical part from the ground to the height at which it is to be installed.

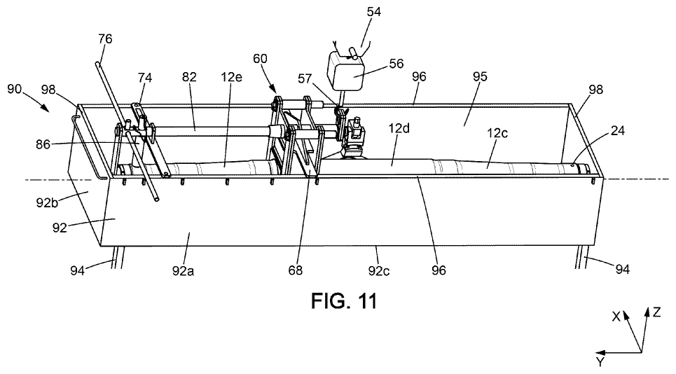

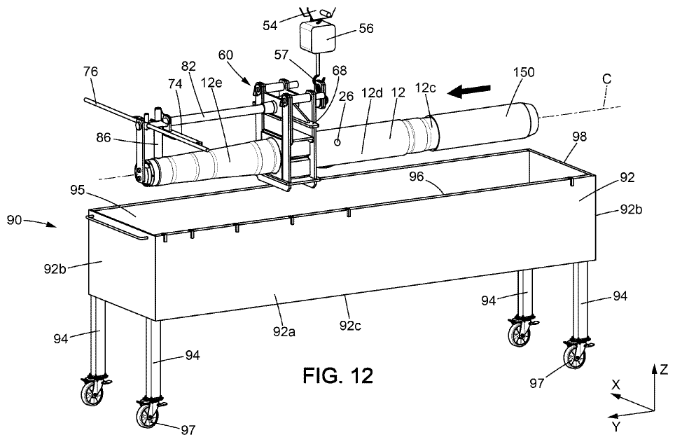

In certain cases, the lifting device further comprises a hooking device 57, visible in FIGS. 11 and 12, which is connected to one end of the chain of hoist 56.

The gantry may further comprise a contact arm 58 in contact with another mechanical part, referred to as a receiving part, in which the raised mechanical part is to be installed. Advantageously, contact arm 58 is removably connected to one of vertical members 54.

As is particularly visible in FIGS. 1 and 2, the contact arm extends in the form of an L from one of vertical members 54 of gantry 30. On a first portion 58a of the L, contact arm 58 extends substantially parallel to direction Y, and is substantially aligned along direction X with horizontal member 32 positioned in contact with first end portion 50a of rail 50. On a second portion 58b of the L, contact arm 58 projects relative to gantry 30 substantially parallel to direction Y. Advantageously, second portion 58b of the L is positioned laterally relative to rail 50, which prevents contact arm 58 from interfering with movement of the raised mechanical part during its installation in the receiving part.

As is particularly visible in the detailed enlargement in FIG. 3, second portion 58b of the L is connected to a support unit 58c of the receiving part. Support unit 58c extends substantially parallel to third direction Z. Advantageously, support unit 58c comprises a substantially concave support face 58d against which the receiving part comes into contact. Support unit 58c may further comprise a strap 58e. Strap 58e is for example arranged adjacent to support face 58d. Strap 58e allows fixing the receiving part to the support unit so as to limit the relative movements between the receiving part and gantry 30 during assembly of the raised mechanical part in the receiving part.

Advantageously, gantry 30 is mainly made of steel or aluminum in order to limit its weight. Preferably, each of the members and the rail have a weight that is less than or equal to 50 kg, more preferably less than or equal to 40 kg. For example, each of the members and the rail may have a weight that is less than or equal to 36 kg.

The arrangement of each of the parts in gantry 30 as described above and illustrated in FIGS. 1 and 2 corresponds to an operational position of the gantry. Note, however, that each of the parts which form gantry 30 are unit parts which are connected together by removable connections, as described above. “Unit part” is understood to mean a structurally independent part. The gantry may thus be in a dismantled position, where each of the unit parts is separated from the others and may adopt any position in a spatial frame of reference. Also, when the gantry is in the dismantled position, all the unit parts may be arranged so as to occupy a reduced volume compared to the volume occupied by the gantry in the operational position. The parts may therefore be stored compactly, facilitating their movement from one location to another, whether by land, sea, or air.

Also note that due to the means for rigid connection and continuous movement of each vertical member 34, the height of gantry 30, and in particular the distance of frame 40 from the ground S, may be increased without needing to use raising means external to the gantry or human force. Raising member 44 of each foot also contributes to this objective. Also, gantry 30 may be installed and adjusted at any location without needing to transport heavy machinery and without endangering the operators installing it.

Also note that the presence of at least three first members makes it possible to increase the resistance of the gantry to raised loads when in service, in particular to the weight of the raised mechanical part.

Finally, note that due to the presence of at least three vertical members 34, the stability of gantry 30 is improved, which allows reducing the risks of gantry failure and consequently increases the safety of any operator working under gantry 30. Similarly, when the raised part is to be installed in the receiving part, the stability of gantry 30 makes it possible to carry out a rapid installation of the mechanical part in the raised part. In particular, the installation time may be around 30 seconds.

A method of erecting gantry 30 will now be described.

The method first comprises assembling the frame. This step is carried out by connecting each of the first and second end portions of one of the horizontal members to another respective horizontal member, as explained above.

In one practical example of assembling frame 40, visible in FIG. 4, horizontal members 32 are arranged on a support 200 at a distance from the ground S. Support 200 comprises for example a plurality of support element units 210. Each support element unit is for example a trestle. Advantageously, the number of support element units is equal to the number of horizontal members 32 in gantry 30. The first end portion of each horizontal member 32 can thus rest on one of support element units 210, and the second end portion of each horizontal member can rest on another of support element units 210.

Advantageously, the height of support element units 210 is less than or equal to 1 m, preferably between 0.8 m and 1 m. The operators manipulating the parts of gantry 30 therefore do not have to exert significant physical effort in order to arrange first members 32 on support element units 210. Advantageously, all support element units 210 have the same height.

After the frame is assembled, rail 50 and vertical members 34 are connected to frame 40. While connecting rail 50 and vertical members 34 to the frame, the frame is advantageously held on support 200.

The order of connection of rail 50 and vertical members 34 to frame 40 is irrelevant: rail 50 may be assembled on frame 40 before connecting vertical members 34, or vice versa.

As indicated above, vertical members 34 are connected to the frame by their first end portion so that each vertical member 34 is hinged to rotate on the frame about an axis parallel to the plane parallel to horizontal members 32, in this case plane XY. After connecting the respective vertical member 34 to frame 40, foot 34b of vertical member 34 is oriented towards ground S, rolling element 42 being in contact with ground S. Because the height of support element units 210 on which frame 40 rests is less than 1 meter, in this configuration vertical members 34 are in the first position described above, i.e. the position in which the angle that vertical members 34 form with the frame is less than 90°. This avoids having to use means to support frame 40 at a sufficient height to allow connecting vertical members 34 directly in their operational position, which in this case is substantially parallel to direction Z.

The method further comprises connecting each vertical member 34 to one of horizontal members 32 via the means for rigid connection and continuous movement, as explained above. According to one example, all the means for rigid connection and continuous movement are connected to the respective vertical 34 and horizontal 32 members after connecting all vertical members 34 to frame 40. Alternatively, immediately after connecting one of vertical members 34 to the frame, the means for rigid connection and continuous movement associated with vertical member 34 are installed.

As indicated above, the means for rigid connection and continuous movement may be winches 48, in particular rack and pinion winches. In the figures, winches 48 will be mounted between vertical members 34 and only those horizontal members 32 substantially parallel to a single direction, as indicated above. As has also been explained, in this configuration the actuation of each winch 48 imparts a rotational movement to the respective vertical member 34, about a direction parallel to the direction of extension of the horizontal member 32 to which vertical member 34 is connected by the winch. This allows easily moving vertical members 34 from the first position to the operational position, visible in FIGS. 1 and 2.

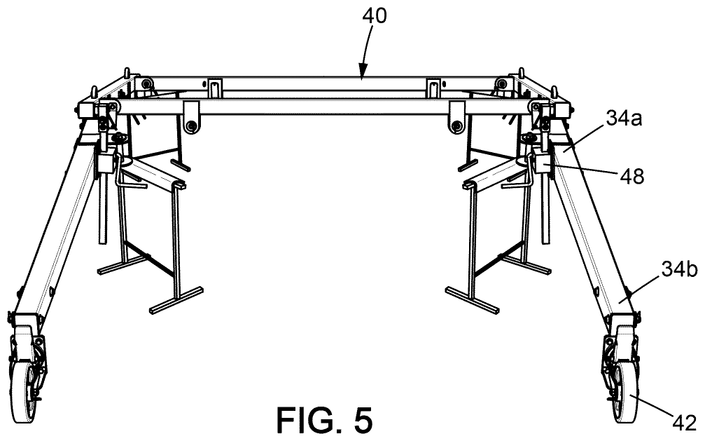

As shown in FIG. 5, the method lastly comprises rotating each second member about the corresponding axis between the first position obtained and the operational position, by actuating the means for rigid connection and continuous movement.

Advantageously, before operating winches 48 to position vertical members 34 in their operational position, the movements in plane XY of wheels 42 that are part of two vertical members 34 located on a first side of gantry 30 relative to rail 50 are immobilized. To do this, the holding brake is actuated for the wheels 42 that are part of two vertical members 34 located on said first side of gantry 30.

After immobilizing wheels 42 of vertical members 34 located on the first side of gantry 30, with respect to rail 50, winches 48 associated with the two vertical members 34 located on a second side of gantry 30 with respect to rail 50 are operated, preferably synchronously. Said second side is opposite said first side of gantry 30. Actuation of the holding brake of wheels 42 on the first side of gantry 30 prevents the actuation of winches 48 associated with the two vertical members 34 located on the second side of gantry 30 from causing a translational movement of the entire gantry 30 within plane XY. Winches 48 associated with the two vertical members 34 located on the second side of gantry 30 are actuated until vertical members 34 of said second side of gantry 30 adopt their operational position along direction Z.

Once vertical members 34 located on the second side of gantry 30 are in their operational position substantially parallel to direction Z, stiffeners 46 connecting horizontal members 32 and the vertical members 34 located on the second side of gantry 30 may be installed. As stiffeners 46 are rigid, once installed the rotation of the respective vertical member 34 about its axis is no longer permitted.

After unlocking the movement of wheels 42 associated with vertical members 34 on the first side of gantry 30, the steps of actuating the holding brakes, actuating the winches, and installing the connecting bars may then be carried out on the reverse sides of gantry 30 relative to rail 50. This allows placing vertical members 34 located on the first side of gantry 30 in the operational position along direction Z.

Once all vertical members 34 are in the operational position, raising element 44 for each leg 34b may be installed on the respective vertical member 34. Similarly, contact arm 58 may be connected to the corresponding vertical member 34.

To complete the erection of the gantry, trolley 54 and hoist 56 are installed. To install trolley 56 on the rail, at least one of locking elements 52 of rail 50 is moved to the unlocking position. This allows trolley 56 to be introduced onto the rail. Once trolley 54 has been introduced onto rail 50, locking element 52 is returned to the position which locks rail 50 in order to prevent trolley 54 from leaving rail 50 during its translational movement along the longitudinal direction of the rail. Hoist 56 is suspended from the trolley.

Note that due to the means for rigid connection and movement of the second members, the method of erecting the gantry according to the invention does not require employing heavy machinery, and the use of human force is limited to what is used to arrange the first members on the support element units and to assemble the rail on the frame.

An example use of the gantry will now be described.

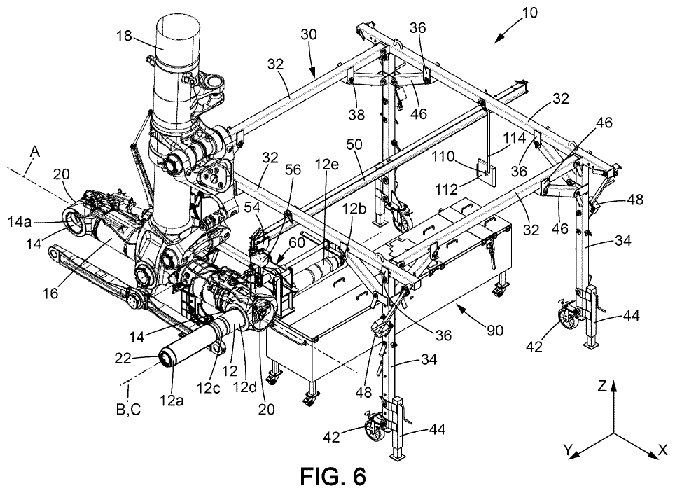

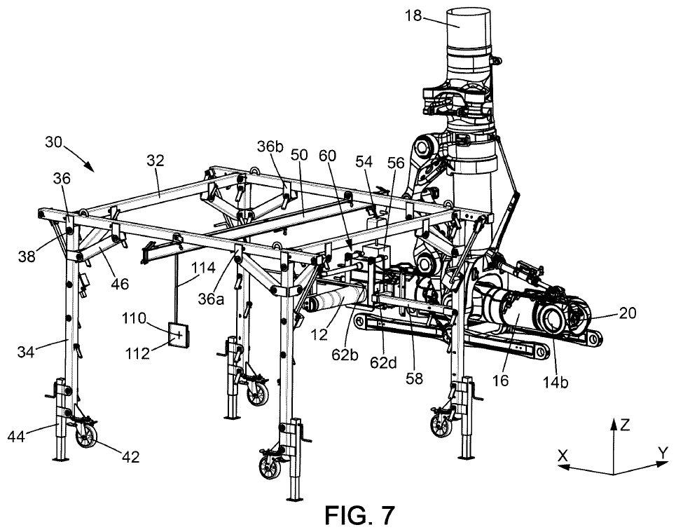

Gantry 30 may be part of a system 10 for mounting an axle 12 in a bore 14 of a bogie 16, visible in FIGS. 6 and 7. Bogie 16 is preferably mounted on a landing gear 18 of an aircraft, for example an airplane.

Bogie 16 has an elongate shape and extends between two open ends 20. Bogie 16 has in particular a substantially cylindrical shape of axis A. Advantageously, bogie 16 is made of titanium.

Bogie 16 comprises a plurality of bores 14. In the example of FIGS. 6 and 7, bogie 16 comprises two bores 14, but this number is not limiting, as bogie 16 may comprise a single bore or more than two bores.

Each bore 14 extends between a first open end 14a and a second open end 14b such that bore 14 is a through-bore. Each bore 14 has, for example, a substantially cylindrical cross-section of axis B, axis B being substantially perpendicular to axis A of bogie 16. Advantageously, each open end 20 of bogie 16 is in communication with one of bores 14.

In FIGS. 6 and 7, landing gear 18 is in a gear-down position, meaning a normal position of use for landing gear 18 in which the wheels of the landing gear, not shown, are in contact with the ground. In this gear-down position, axis A of bogie 16 extends substantially parallel to first direction X and axis B of each bore 14 extends substantially parallel to second direction Y.

Axle 12 has an elongate tubular shape, with a substantially cylindrical cross-section, extending between a first end 12a and a second end 12b. Advantageously, a cavity 22 extends inside axle 12 between first end 16a and second end 16b. Axle 12 therefore comprises an outer wall and an inner wall, the inner wall defining cavity 22 of the axle. Cavity 22 is preferably substantially cylindrical, with an axis C. When the axle is mounted in the bogie bore, axis B of the bogie bore and axis C of the axle are coaxial, as shown in FIGS. 6 and 7.

Axle 12 comprises a first end portion 12c, a central portion 12d, and a second end portion 12e. Central portion 12d extends between first and second end portions 12c, 12e. First end portion 12c and second end portion 12e extend between central portion 12d and, respectively, first end 12a and second end 12b of axle 12.

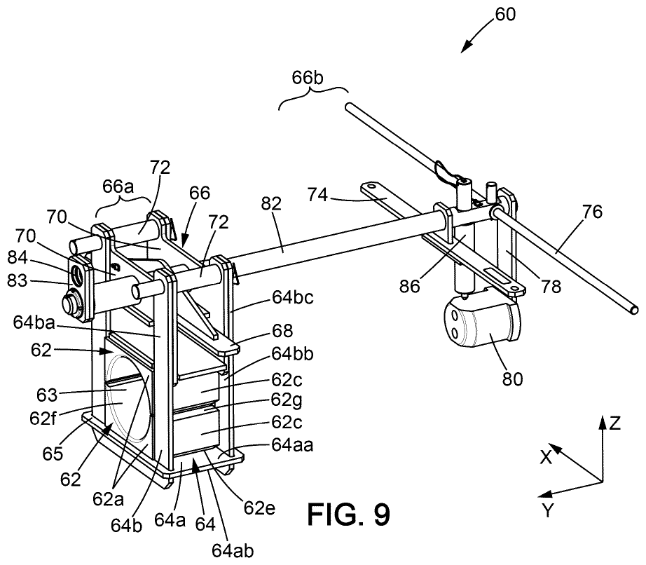

A first bore 24, visible in FIG. 11, traverses the outer wall of axle 12 in a substantially radial manner. First bore 24 is arranged in first end portion 12c of axle 12. A second bore, similar to the first bore but not visible in the figures, is preferably arranged in second end portion 12e of axle 12. As will be detailed below, the second bore makes it possible to orient axle 12 and hold it in position in an axle support 60 which will be described in detail with reference to FIG. 9. Advantageously, the first bore and second bore are aligned along an axis parallel to axis C of the axle. In central portion 12d of axle 12, a third bore 26, illustrated in FIG. 12, traverses the inner and outer walls of axle 12. Third bore 26 is arranged at approximately 90° relative to first bore 24 around axis C. The third bore is advantageously at the same distance from first and second ends 12a, 12b of axle 12.

As will be detailed below, in particular with reference to FIG. 12, first and second end portions 12c, 12e advantageously have a substantially smaller cross-section than the cross-section of the central portion. “Cross-section” is understood to mean an external cross-section of axle 12 obtained by projection onto plane XZ when axle 12 extends substantially parallel to second direction Y. Preferably, the cross-section of central portion 12d of axle 12 has a dimension substantially equal to that of bore 14, so as to be able to insert axle 12 into bore 14 as will be explained below.

Preferably, axle 12 is made of metal, for example steel.

System 10 will now be described, with reference to the figures.

System 10 comprises gantry 30 described above. FIG. 6 illustrates gantry 30 in use and at the end of mounting an axle 12 in a bore 14 of a bogie 16. In this configuration, contact arm 58 of the gantry is advantageously in contact with the bogie. More precisely, bogie 16 comes into contact with support face 58d and is held in this position by means of strap 58e. Relative movements between bogie 16 and gantry 30 while mounting axle 12 in bore 14 are thus limited.

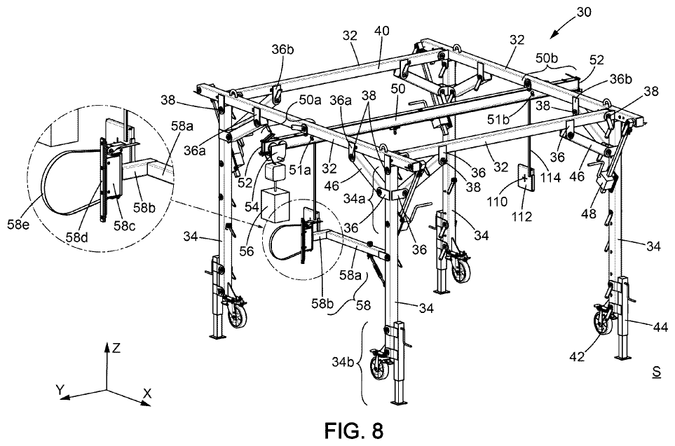

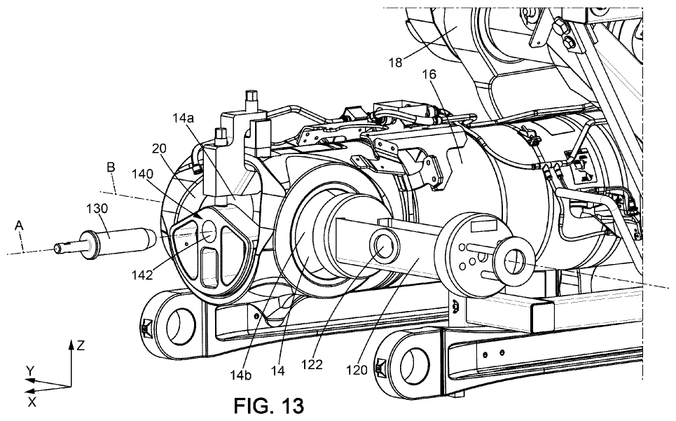

System 10 further comprises means for aligning axis B of the bogie bore with axis C of the axle. These alignment means may comprise a reference mark 110, visible in FIGS. 6 to 8, and a laser beam device 120, visible in FIG. 13.

Reference mark 110 is arranged on one face of a target 112 carried by gantry 30. In particular, the target is suspended from one of holes 51a, 51b provided in first end portion 50a and second end portion 50b of rail 50. In particular, target 112 is connected to one of holes 51a, 51b of the first and second end portions of the rail, by a suspension element 114. Advantageously, the length of suspension element 114 is chosen so that reference mark 110 and axis C of axle 12 are aligned along direction Z when axle 12 is carried by hoist 56 and the chain of hoist 56 is in the high position.

Reference mark 110 has for example a cross shape with a first line substantially parallel to direction Z and a second line substantially parallel to direction X when target 112 is suspended from the rail.

Laser beam device 120 is a device which emits a laser beam. Laser beam device 120 is adapted for installation in the bogie bore. More precisely, laser beam device 120 is adapted so that, when installed in the bore, the axis of the laser beam is coaxial with axis B of bogie bore 14.

Advantageously, the laser beam has the same shape as reference mark 110. For example, the laser beam has the shape of a cross with a first ray substantially parallel to direction Z and a second ray substantially parallel to direction X when laser beam device 120 is installed in bore 14.

As can be seen in FIG. 13, laser beam device 120 comprises a bore 122 located in a substantially central position of laser beam device 120 along direction Y. Once laser beam device 120 is installed in its final position in the bore, bore 122 receives a retaining rod 130 to hold it in position.

In order to identify the final position of the laser in the bore, the system may further comprise a guide tool 140, visible in FIG. 13. The guide device is configured to be arranged on open end 20 of bogie 16 which is in communication with bore 14 where axle 12 will be installed. The guide device comprises a hole 142 having a shape and a dimension substantially equal to those of bore 122 of laser beam device 120. When laser beam device 120 is in its final position in bore 14, hole 142 of guide tool 140 and bore 122 of the laser beam device are aligned. Retaining rod 130 may then be inserted into bore 122 of laser beam device 120, through hole 142 of guide tool 140.

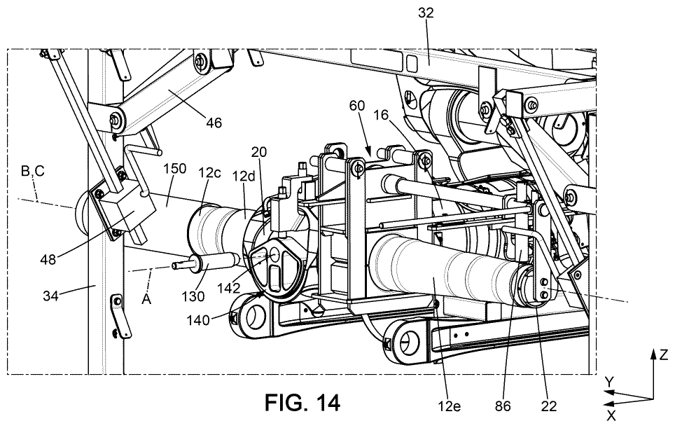

As can be seen in FIG. 14, guide tool 140 also serves to identify a final position of axle 12 in bore 14, similar to the identification of the final position of the laser beam device. In particular, hole 142 of guide tool 140 is substantially equal in shape and dimension to third bore 26 of axle 12. When axle 12 is in its final position in bore 14, hole 142 of guide tool 140 and third bore 26 of the axle are aligned.

Retaining rod 130 also serves to retain axle 12 in its final position in bore 14. In particular, when hole 142 of guide tool 140 and third bore 26 of the axle are aligned, retaining rod 130 may be inserted into bore 26 of axle 12 through hole 142 of guide tool 140.

System 10 may further comprise an axle support 60, shown in FIG. 9. Advantageously, axle support 60 is made of metal, for example stainless steel due to its thermal and mechanical properties.

Axle support 60 comprises two half-collars 62, a collar support 64, and a spreader 66. Each of these parts of axle support 60 will be described below in relation to the position that it adopts in FIG. 9 using the orthonormal frame of reference formed by directions X, Y and Z. Note, however, that axle support 60 is advantageously removable, these parts advantageously being detachable from each other. Thus, in a disassembled position of the axle support, not illustrated, these parts of the axle support are separate from each other and can adopt any spatial position.

The two half-collars 62 are preferably identical. The same references will therefore be used to describe the same parts of the two half-collars.

Each half-collar is composed of a block comprising a front face 62a, a rear face 62b (visible in FIG. 7), a first side face 62c, and a second side face 62d (visible in FIG. 7). Front face 62a and rear face 62b are opposite and substantially parallel to each other. In FIG. 9, front 62a and rear 62b faces extend substantially parallel to plane XZ. Preferably, front 62a and rear 62b faces are identical. Side faces 62c, 62d are opposite and substantially parallel to each other. In FIG. 9, the side faces extend substantially parallel to plane YZ. Preferably, the two side faces 62c, 62d are identical.

Each side face 62c, 62d connects front face 62a and rear face 62b of each half-collar 62. Advantageously, a shoulder (not visible in the figures) exists between front face 62a and each side face 62c, 62d, as well as between rear face 62b and each side face 62c, 62d of the half-collar. Each shoulder allows each half-collar 62 to be fitted into collar support 64, as will be explained below.

Each half-collar 62 further comprises a flat face 62e and a concave face 62f. Flat face 62e and concave face 62f connect front 62a and rear 62b faces of each half-collar 62. Advantageously, flat 62e and concave 62f faces are substantially perpendicular to side faces 62c, 62d of the respective half-collar 62.

Flat face 62e is substantially rectangular, and opposite to concave face 62f. Concave face 62f has a concavity. Two substantially flat edges 62g extend on concave face 62f between each end of the concavity and the respective side face 62c, 62d of the half-collar.

The substantially flat edges allow the two half-collars 62 to be stacked so that their concavities face each other. In particular, in order to stack two half-collars 62, substantially flat edges 62g of concave face 62f of one of half-collars 62 are placed in contact with substantially flat edges 62g of concave face 62f of the other half-collar 62. Two half-collars 62 thus form a collar traversed by an opening 63 for receiving axle 12. As can be seen from FIG. 9, opening 63 for receiving axle 12 is defined by the concavities of the two half-collars. Advantageously, the shape and dimension of opening 63 for receiving axle 12 are substantially equal to the cross-section of central portion 12d of axle 12. Axle 12 may thus be kept immobilized between two half-collars 62 as will be detailed below.

Collar support 64 comprises a support surface 64a and four connecting segments 64b.

Support surface 64a is flat. In FIG. 9, the support surface extends substantially parallel to plane XY. The support surface comprises an upper face 64aa and a lower face 64ab. Upper face 64aa comprises a support area (not visible) and a peripheral area 65.

The support area has a shape and dimension substantially equal to the flat face of one of half-collars 62. The support area is thus intended to receive and support flat face 62e of one of half-collars 62. Peripheral area 65 surrounds the support area. Peripheral area 65 preferably has a substantially rectangular loop shape.

Support surface 64a is configured to support the collar formed by two half-collars 62 as indicated above.

Each connecting segment 64b has a substantially flat shape comprising an external face 64ba, an internal face 64bb, and two side edges 64bc. Each connecting segment 64b extends substantially perpendicularly to support surface 64a. In the current case, each connecting segment 64b extends substantially parallel to third direction Z.

As can be seen in FIG. 9, four connecting segments 64b are arranged on peripheral area 65 of support surface 64a. Connecting segments 64b are advantageously facing each other in pairs along first direction X. The connecting segments are advantageously also facing each other in pairs along second direction Y. Preferably, connecting segments 64b are separated along direction X or direction Y by distances which allow one of side edges 64bc and the internal face 64bb of each connecting segment 64b to be in contact with one of the shoulders arranged between side faces 62c, 62d and front 62a or rear 62b face of each half-collar 62. Each half-collar 62 is thus fitted into axle support 60 between four connecting segments 64b, which prevents the collar from moving in first direction X and in second direction Y when the collar is installed on support surface 64a.

An end portion of each connecting segment that is opposite the support surface is traversed by a hole (not visible in the figures). Advantageously, the holes of connecting segments 64b arranged facing each other in direction X are aligned with each other. These holes allow connecting collar support 64 and spreader 66 as will be detailed below.

Spreader 66 comprises a front part 66a and a rear part 66b.

Front part 66a comprises a first arm 68 and two plates 70. First arm 68 extends substantially in direction X. In the non-limiting example of FIG. 9, plates 70 are separated along direction Y by a distance that is substantially less than the distance which separates two connecting segments 64b along direction Y. Thus, two plates 70 may be arranged between four connecting segments 64b. Each plate comprises two holes (not visible in the figures) which are arranged, along direction Y, facing the holes that traverse connecting segments 64b when the plates are arranged between segments 64b. Thus, a rod 72 can pass through the holes of the two plates 70 and of the two segments 64b arranged facing each other along direction Y. Each rod 72 therefore allows connecting collar support 64 and spreader beam 66.

Rear part 66b of the spreader comprises an arm 74, a push bar 76, and an end portion 78. Arm 74 and push bar 76 extend substantially along direction X, while end portion 78 extends substantially along direction Z. End portion 78 is connected to a guide cylinder 80 arranged substantially facing push bar 76 along direction Z and extending substantially along direction Y.

Front 66a and rear 66b parts of spreader 66 are connected together by a crosspiece 82 which extends substantially in direction Y. Crosspiece 82 comprises, on one end near front part 66a of spreader, a part 83 extending substantially in direction Z and comprising an orifice 84. Orifice 84 allows the attachment of hooking device 57 of the hoist. Axle support 60 may thus be moved in direction Z by means of the movement of the chain of hoist 56, and in translation along the direction in which rail 50 extends when hoist 56 integrally follows the movement of trolley 54. On another end near rear part 66b of the spreader 66, crosspiece 82 is traversed by a through-hole (not visible in the figures) which passes through crosspiece 82 substantially in direction Z. As can be seen in FIG. 9, this through-hole is adapted to receive a rod 86.

As is particularly visible in FIGS. 11 and 12, when axle 12 is received in opening 63 of the collar formed by two half-collars 62, the axle is arranged so that guide cylinder 80 is inserted into cavity 22 of axle 12 and rod 86 is inserted into the second bore arranged in second end portion 12e of axle 12. This arrangement allows maintaining the axle in position in axle support 60, and guaranteeing that axle 12 is oriented in a position which ensures that when axle 12 reaches its final position in bore 14, bore 26 and the hole of the guide tool are aligned and facing each other.

System 10 further comprises a tank 90, shown in FIGS. 6, 10, 11 and 12. Tank 90 comprises a vessel 92 and a plurality of substantially vertical members 94.

Vessel 92 has, for example, the shape of a rectangular parallelepiped, but other shapes are possible. In the figures, vessel 92 is defined by two longitudinal walls 92a, two transverse walls 92b, a lower wall 92c, and an upper wall 92d. Longitudinal walls 92a extend in two planes substantially parallel to each other and along plane YZ. Transverse walls 92b extend in two planes substantially parallel to each other and along plane XZ. Lower 92c and upper 92d walls extend in two planes substantially parallel to each other and along plane XY.

As can be seen from FIGS. 11 and 12, the interior 95 of vessel 92 forms a trough. The interior of vessel 94 advantageously has a length and a width respectively greater than the length and width of axle 12, which allows placing the axle in tank 90, as will be detailed below.

Each longitudinal wall has a thickness which defines a longitudinal edge 96 of the vessel. Similarly, each transverse wall has a thickness which defines a transverse edge 98 of the vessel.

As is clearly shown in FIG. 11, arms 68, 74 of the spreader, as well as push bar 76, have a length greater than the width of vessel 92. Thus, arms 68, 74 and push bar 76 rest on longitudinal edges 96 of vessel 92 when axle 12 and axle support 60 are arranged in the vessel. This prevents axle support 60 from touching the bottom of vessel 92 when placed inside vessel 92.

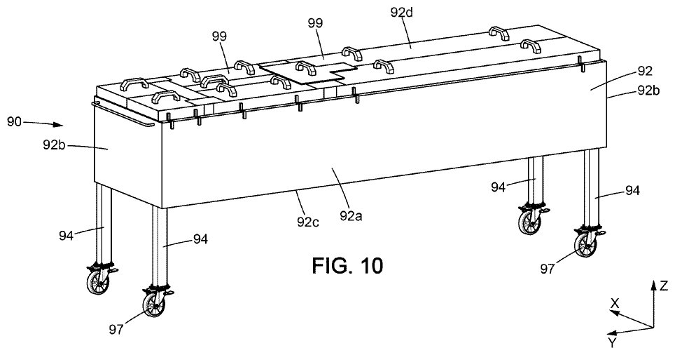

As is clearly shown in FIG. 10, upper wall 92d of the vessel comprises a plurality of removable covers 99, so as to define an open position and a closed position of vessel 92. In the closed position, covers 99 are arranged on the vessel, to prevent access to the interior 95 of vessel 92. In the open position, all covers 99 are removed from vessel 92, which allows access to its interior 95.

Advantageously, one or more covers 99 has a shape adapted to allow the passage of axle support 60, in particular arms 68, 74 and push bar 76, when axle 12 is placed in the tank. These covers, whose shape allows the passage of axle support 60, allow defining a third position of vessel 92, referred to as the axle cooling position. In the axle 12 cooling position, all covers 99 are arranged on vessel 92, with the exception of the covers whose shape allows the passage of axle support 60. This makes it possible to close off vessel 92 as much as possible when axle 12 is inside, while allowing arms 68, 74 and push bar 76 to rest on longitudinal edges 96 of vessel 92, in a manner that limits the transfer of heat to the outside.

Vessel 92 is intended to be filled with liquid nitrogen in the axle cooling position.

Vessel 92 is supported by the plurality of substantially vertical members 94. These members extend substantially parallel to direction Z, from lower face 92d of the vessel. In the figures, tank 90 comprises four substantially vertical members 94 placed under each intersection between the longitudinal and transverse walls. Of course, tank 90 could comprise more than four members.

Advantageously, each vertical member comprises a foot provided with a rolling element 97 such as a wheel. Wheel 97 allows moving tank 90 around within plane XY. The tank may thus easily be placed under gantry 30, as can be seen in FIG. 6.

Gantry 30 may then be used to implement a method for mounting axle 12 in bogie 16 using the system of FIG. 6. In the following, we will describe in particular the method for mounting the axle in one of the bogie bores of axis B. In the following, a direction along axis B of the bore will be referred to as the “axle installation direction”.

The method firstly comprises the providing of mobile gantry 30.

In certain cases, gantry 30 will already be erected and it will only be necessary to move it along plane XY until support face 58d which is connected to contact arm 59 of gantry 30 comes into contact with bogie 16 installed in landing gear 18. Strap 58e of support unit 58c will then be arranged around bogie 16 to prevent relative movements between gantry 30 and bogie 16.

In other cases, gantry 30 is not erected beforehand. Gantry 30 is then erected according to the erection method described above.

After erection of the gantry, it is in the operational position and may be moved within plane XY until support face 58d which is connected to contact arm 58 of gantry 30 comes into contact with bogie 16 installed in landing gear 18.

The method further comprises a step of installing the axle on the means for moving the axle. As indicated above, the means for moving the axle comprise rail 50, trolley 52, and hoist 54.

Firstly, the step of installing axle 12 in the means for moving axle 12 allows positioning axle 12 on axle support 60. In particular, hooking device 57 of the hoist is connected to the axle, which is moved while suspended from hoist 56 until it is installed on one of half-collars 62 already placed on support surface 64a of axle support 64.

The other half-collar 64 and the spreader 66 may then be installed so as to lock axle 12 in opening 63, in accordance with the configuration described above with reference to FIGS. 9 and 11. In particular, when axle 12 is received in opening 63 of the collar formed by two half-collars 62, axle 12 is arranged so that guide cylinder 80 is inserted into cavity 22 of axle 12 and rod 86 is inserted into the second bore provided in second end portion 12e of axle 12. As indicated above and as is clearly visible in FIG. 12, axle 12 will be locked in opening 63 by central portion 12d.

Once axle support 60 is correctly installed around axle 12, hooking device 57 of hoist 56 is hooked to orifice 84 provided near front part 66a of spreader 66 of axle support 60. Then, the chain of hoist 56 is gradually moved from its low position to its high position. The configuration of the axle support guarantees that the assembly formed by the axle and the axle support is held by its center of gravity, which allows keeping axle 12 in a position substantially parallel to horizontal plane XY during its movement via the means for moving the axle.

Moving the hoist chain to the high position allows aligning axis C of the axle and axis B of the bore, so that the axle extends along the axle installation direction.

The alignment of axes B and C of bore 14 and axle 12 may be obtained by means of the laser beam device and the reference mark. In particular, as explained above, laser beam device 120 is installed in bore 14 of the bogie so that axis B of bore 14 is aligned with the laser beam emitted by laser beam device 120. As indicated above, when installing laser beam device 120 in bore 14, guide tool 140 may be employed to detect the final position of laser beam device 120 in bore 14, and rod 130 may be used to lock laser beam device 120 in this final position.

Furthermore, also as indicated above, the chain of hoist 56 is configured so that in the high position, axis C of the axle is necessarily aligned with reference mark 110. Also, in order to ensure that axis C of the axle and axis B of the bore are aligned, the method may comprise a step of aligning the laser beam and reference mark 110. For this purpose, reference mark 110 is initially carried by hole 51a of first end portion 50a of the rail. Gantry 30 is then moved along direction Y by means of rolling elements 42, and along direction Z by means of raising elements 44, until the laser beam and reference mark 110 are coincident. The continuous movement to adjust the height of gantry 30 allows achieving a precise coaxial adjustment of axis C with plane XY containing axis B.

If reference mark 110 and the emitted laser beam have the shape of a cross, the laser beam and reference mark 110 are coincident when the vertical line of reference mark 110 and the vertical ray of the laser beam are aligned, and when the horizontal line of reference mark 110 and the horizontal ray of the laser beam are aligned. After this first alignment between the vertical line and vertical ray, and between the horizontal line and horizontal ray, reference mark 110 is removed from hole 51a of first end portion 50a of rail 50 and then carried by hole 51b of second end portion 50b of the rail. If, in this position, the laser beam and the reference mark are not coincident, the gantry is again moved along direction Y and direction Z until they are coincident, as explained above.

With the laser beam aligned with axis B of bore 14, the alignment between the laser beam and reference mark 110 implies that axis B and reference mark 110 are also aligned. Reference mark 110 is then arranged in a vertical plane which contains the axle 12 installation direction. As reference mark 110 and the hoist are carried by rail 50, the vertical plane comprising the axle installation direction as well as reference mark 110 also corresponds to a lifting plane of axis C of axle 12.

Note that reference mark 110 is fixedly mounted relative to the rail. In other words, when gantry 30 moves along direction Y and along direction Z, the relative position between reference mark 110 and the rail does not change. Indeed, reference mark 110 and rail 50 are moved integrally with gantry 30. Rolling elements 42 and raising elements 44 therefore constitute not only means for moving gantry 30, but also means for moving reference mark 110.

Once axis C of the axle and axis B of bore 14 are aligned, the method comprises inserting axle 12 into bore 14 of the bogie, as can be seen in FIG. 14. In particular, in order to insert the axle into the bore, the hoist is connected to axle support 60, in particular to orifice 84 as indicated above. Trolley 54 then moves in the axle installation direction, which causes movement of hoist 56 and axle 12 in this same direction. Trolley 54 and hoist 56 are in particular moved along the axle 12 installation direction until the final position of axle 12 in bogie 16 is identified using guide tool 140 as described above. Once in the final position, axle 12 is fixed in the bore by means of retaining rod 130.

In order to improve the securing of the axle in the bore, assembly by thermal difference may also be used. For this purpose, as can be seen in FIG. 11, the axle/axle support assembly is placed in vessel 92 of tank 90. In particular, axle 12 is placed in vessel 92 in a horizontal position, i.e. along plane XY. Vessel 92 is then put in its axle cooling position. As indicated below, in the axle cooling position all covers 99 are arranged on vessel 92, with the exception of the covers whose shape allows the passage of axle support 60. Vessel 92 is then filled with liquid nitrogen. Liquid nitrogen allows the axle to be cooled to approximately −200° C., which causes axle 12 to contract. In order to reach such a temperature, the axle is kept in tank 90 filled with liquid nitrogen for one hour for example. When the axle is extracted from tank 90, the contraction caused by the low temperatures facilitates insertion of the axle into bore 14. Once in bore 14, the temperature of the axle increases, causing expansion of the axle which leads to an increase in its outer diameter until it is locked in place in the bore by its expansion in the bore at ambient temperature.

To improve this assembly by thermal difference, bore 14 of the bogie may be heated to a given temperature, for example +100° C. This causes the bore to expand. Insertion of axle 12 into bore 14 is thus facilitated. Once in the bore, the temperature of bore 14 decreases to ambient temperature, causing contraction of the bore which allows increased clamping of the axle in bore 14.

To heat bore 14, heating means, such as a resistor for example (not shown), may be placed in bore 14. Optionally, a temperature sensor (not shown) may also be inserted into bore 14 to control its heating.

Advantageously, before inserting axle 12 into bore 14, a sleeve 150, visible in FIGS. 6 and 14, is arranged around the end of axle 12 which is facing bore 14 in the axle installation direction, in this case first end 12a of the axle. In other words, sleeve 150 is arranged around the end portion of axle 12 which passes entirely through bore 14 in order to place axle 12 in its final position in bore 14. Sleeve 150 makes it possible to avoid direct collisions between axle 12 and bore 14, and to limit a loss of alignment between axis C of the axle and axis B of the bore which could be facilitated by the difference in cross-section between first end portion 12c and central portion 12d of the axle. Sleeve 150 is advantageously removed after the installation of axle 12 in bore 14.

As shown in FIG. 12, when axle 12 is placed in tank 90 filled with liquid nitrogen, sleeve 150 may be installed around the first end of axle 12 after axle 12 is extracted from tank 90.

1. A gantry crane comprising:
a frame having at least three first members extending parallel to a first plane and each first member including a first end portion and an opposite second end portion, each of the first and second end portions of one of the first members being connected to another respective first member;
a longitudinal rail supported by the frame and extending parallel to the first plane, and on which a lifting device for lifting a mechanical part is hinged for longitudinal movement; and
at least three second members extending between a first end portion and an opposite second end portion, the first end portion of each second member being hinged to rotate on the frame about an axis parallel to the first plane, each second member further being connected to the frame by means for rigid connection and continuous rotational movement of the second member relative to the frame, each second member being rotatable between a first position in which the second member forms an angle of less than 90° with the first plane, and a second position in which the second member is substantially perpendicular to the first plane.

2. The gantry according to the preceding claim 1, wherein the means for rigid connection and continuous rotational movement are specific to each second member and are independent of the means for rigid connection and continuous rotational movement of the other second members.

3. The gantry according to claim 1, wherein the means for rigid connection and continuous rotational movement comprise a rack and pinion winch connected to each second member.

4. The gantry according to claim 1, further comprising a plurality of stiffeners, each stiffener connecting one of the first members to one of the second members.

5. The gantry according to claim 1, wherein the second end portion of each second member comprises a raising member configured to move the respective second member substantially perpendicularly to the first plane when the second members are in the second position.

6. The gantry according to claim 1, wherein the second end portion of each second member comprises a rolling element.

7. The gantry according to claim 1, wherein the first members, the second members, the rail, and the means for rigid connection and continuous rotational movement each form a unit part, the unit parts being connected by removable connections.

8. The gantry according to claim 1, comprising four first members and four second members arranged so as to form a cubic structure.

9. Method A method of erecting a gantry crane according to claim 1, the method comprising:
a) assembling the frame by connecting each of the first and second end portions of one of the first members to another respective first member;
b) assembling the rail on the frame;
c) connecting the first end portion of each second member to the frame, the first end portion of each second member being hinged to rotate on the frame about an axis parallel to the first plane;
d) connecting each second member to a first member via the means for rigid connection and continuous rotational movement; and
e) rotating each second member about the axis parallel to the first plane, between the first position obtained in step d) and the second position, by actuating the means for rigid connection and continuous rotational movement.

10. The method according to the preceding claim 9, wherein the gantry crane further comprises a plurality of stiffeners, each stiffener connecting one of the first members to one of the second members, and wherein the method further comprises connecting the respective stiffener between each first member and each second member after moving each second member between the first position and the second position.
